(19) United States
(12) Patent Application Publication
(10) Pub. No.: US 2007/0021956 A1
(43) Pub. Date: Jan. 25, 2007

(54) Method and apparatus for generating ideographic representations of letter based names

(76) Inventors: Yan Qu, Pittsburgh, PA (US); Gregory Grefenstette, St. Cyr L'Ecole (FR)

Correspondence Address: JONES DAY, 500 GRANT STREET, SUITE 3100, PITTSBURGH, PA, 15219-2502, US

(21) Appl. No.: 11/481,584

(22) Filed: Jul. 6, 2006

Related U.S. Application Data
(60) Provisional application No. 60/700,302, filed on Jul. 19, 2005.

(51) Int. Cl. G06F 17/20; G06F 17/27

(52) U.S. Cl. 704/8; 704/9

(57) ABSTRACT

A method of generating an ideographic representation of a name given in a letter based system begins with a determination of the language of original. After determining the language of origin for the name, the name is segmented into a segmentation sequence in response to the determined language of origin. A candidate representation is generated for the segmentation sequence based on ideographic representations of the segments. A corpus is used to validate the candidate representation. The corpus can be either a monolingual corpus or a multilingual corpus. The method can also include adding an additional validation step using either a monolingual corpus or a multilingual corpus, which ever was not used in the first validation step. Because of the rules governing abstracts, this abstract should not be used to construe the claims.

This application claims priority from U.S. patent application Ser. No. 60/700,302 filed Jul. 19, 2005 and entitled Method and Apparatus for Name Translation via Language Identification and Corpus Validation, the entirety of which is hereby incorporated by reference.

### BACKGROUND

This disclosure relates to a method of generating name transliterations and, more particularly, to a method of generating name transliterations where the name's language of origin is taken into account in generating the transliterations.

Multilingual processing in the real world often involves dealing with named entities, sequences of words and phrases that belong to a certain class of interest, such as personal names, organization names, and place names. Translations of named entities, however, are often missing in bilingual translation resources. As named entities are generally good information-carrying terms, the lack of appropriate translations of such named entities can adversely affect multilingual applications such as machine translation (MT) or cross language information retrieval (CLIR).

For example, cross language information retrieval (CLIR) systems often make use of bilingual translation dictionaries to translate user queries from a source language (Ls) to a target language (Lt) in which the documents to be retrieved are written. When a query word in Ls is not found in the bilingual dictionary (hereafter “unknown word”), one needs to determine how to obtain the translations of the unknown word in the target language.

One approach to this problem is simply to pass an unknown word in a query unchanged into the translated query. Another approach is to find the closest matches in surface forms in the target language and treat them as translations. These solutions and their variations are workable if the two languages in question are linguistically (historically) related and possess many cognates.

For language pairs with different writing systems and with little or no linguistic or historical relations, such as Japanese-English and Chinese-English, simple string-copying of a named entity from the source language Ls to the target language Lt is not a solution. Known methods for finding translations for such language pairs include techniques of transliteration, i.e., phonetically-based transcription from letters and syllables in a source language to letters and syllables in a target language, and of back-transliteration, i.e., phonetically-based transcription of letters and syllables back to letters and syllables of the original language (Lₒ). For Chinese-Japanese-Korean (CJK) named entities, Romanization, a process of transliterating or transcribing letters or syllables of a language into the Latin (Roman) script, is commonly used to transcribe the named entities into the Latin script.

Different languages employ different transliteration rules for transcribing the letters or syllables in the original language to those in the target language. For example, Chinese, Korean and Japanese named entities are transcribed to English in different ways. Romanization of Chinese is based on the pinyin system or the Wade-Giles system; Romanization of Japanese is based on the Hepburn Romanization system, the Kunrei-shiki Romanization system, and other variants.

When back-transliterating a named entity in a Latin script into the CJK languages, knowing the language origin of the named entity is important for determining its correct phonetic and ideographic representations. For example, suppose a name written in English is to be translated into Japanese. If the name is of Chinese, Japanese or Korean origin, it is commonly transcribed using Chinese characters (or kanji) in Japanese; if the name is of English origin, then it is commonly transliterated into Japanese using katakana characters, with the katakana characters representing sequences of the English letters or the English syllables.

Known methods in the field have been heavily focused on transliterating named entities of Latin origin into CJK languages, e.g., the work of Knight and Graehl (Kevin Knight and Jonathan Graehl. Machine transliteration. Computational Linguistics: 24(4):599-612, 1998) on transliterating English names into Japanese and the work of Meng et al. (Helen Meng, Wai-Kit Lo, Berlin Chen, and Karen Tang. Generating Phonetic Cognates to Handel Named Entities in English-Chinese Cross-Language Spoken Document Retrieval. In Proceedings of the Automatic Speech Recognition and Understanding Workshop (ASRU 2001), 2001) of transliterating names in English spoken documents into Chinese phonemes. In an attempt to distinguish names of different origins, Meng et al. developed a process of separating the names into Chinese names and English names. Romanized Chinese names were detected by a left-to-right longest match segmentation method, using the Wade-Giles and the pinyin syllable inventories. If a name could be segmented successfully, then the name was considered a Chinese name. Names other than Chinese names were considered foreign names and were converted into Chinese phonemes using a language model derived from a list of English-Chinese equivalents, both sides of which were represented in phonetic equivalents.

A problem with the known methods is that they do not address the problem of detecting the language origins of the named entities or they have not addressed the problem in a systematic way. Thus, they have only solved a part of the named entity translation problem. In multilingual applications such as CLIR and MT, all types of named entities must be translated to their correct representations. Thus, there is a need for a method that identifies the language origins of named entities and then applies language-specific transcription rules for producing appropriate representations.

### SUMMARY

One aspect of the present disclosure is directed to a method of generating an ideographic representation of a name given in a letter based system in which the language of original must be determined. After determining the language of origin for the name, the name is segmented into a segmentation sequence in response to the determined language of origin. A candidate representation is generated for the segmentation sequence based on ideographic representations of the segments. A corpus is used to validate the candidate representation. The corpus can be either a monolingual corpus or a multilingual corpus. The method can also include adding an additional validation step using either a monolingual corpus or a multilingual corpus, which ever was not used in the first validation step.

The previously described method may be modified so as to segment the name into a plurality of segmentation sequences in response to the determined language of origin. Candidate representations are generated for each segmentation sequence based on ideographic representations of the segments to produce a plurality of candidate representations. A corpus is used to rank the plurality of candidate representations. The corpus can be either a monolingual corpus or a multilingual corpus. The method can also include adding an additional ranking step using either a monolingual corpus or a multilingual corpus, which ever was not used in the first ranking step.

Another aspect of the present disclosure is directed to a method of generating an ideographic representation of a name given in a letter based system in which the language of original is known or given. The name is segmented into a segmentation sequence in response to the language of origin. A candidate representation is generated for the segmentation sequence based on ideographic representations of the segments. A monolingual corpus is used to validate the candidate representation and a multilingual corpus is also used to validate the candidate representation.

The previously described method may be modified so as to segment the name into a plurality of segmentation sequences in response to the known or given language of origin. The name is segmented into a plurality of segmentation sequences in response to the language of origin. Candidate representations are generated for each segmentation sequence based on ideographic representations of the segments to produce a plurality of candidate representations. A monolingual corpus is used to rank the plurality of candidate representations and a multilingual corpus is also used to rank the plurality of candidate representations.

The foregoing features and advantages of the present disclosure will become more apparent in light of the following detailed description of exemplary embodiments thereof as illustrated in the accompanying drawings.

### BRIEF DESCRIPTION OF DRAWINGS

For the present disclosure to be easily understood and readily practiced, the present disclosure will be described, for purposes of illustration and not limitation, in conjunction with the following figures wherein:

FIG. 1 is a high-level block diagram of a computer system with which an embodiment of the present disclosure can be implemented.

FIG. 2 is a process-flow diagram of an embodiment of the present disclosure.

FIG. 3 is a process-flow diagram of an embodiment of language profile generation in the Latin script of different languages.

FIG. 4 is a process-flow diagram of an embodiment of identifying the language origin of a given named entity written in the Latin script.

FIG. 5 illustrates an embodiment of validating candidate ideographic representations by step-wise validation through a monolingual corpus in the target language and through a multilingual corpus consisting of the source language and the target language.

FIG. 6 illustrates an embodiment of validating candidate ideographic representations by merging the candidates attested by validation through a monolingual corpus in the target language and through a multilingual corpus consisting of the source language and the target language.

FIG. 7 illustrates an example in terms of the process illustrated in FIG. 2.

### DESCRIPTION OF THE PREFERRED EMBODIMENTS

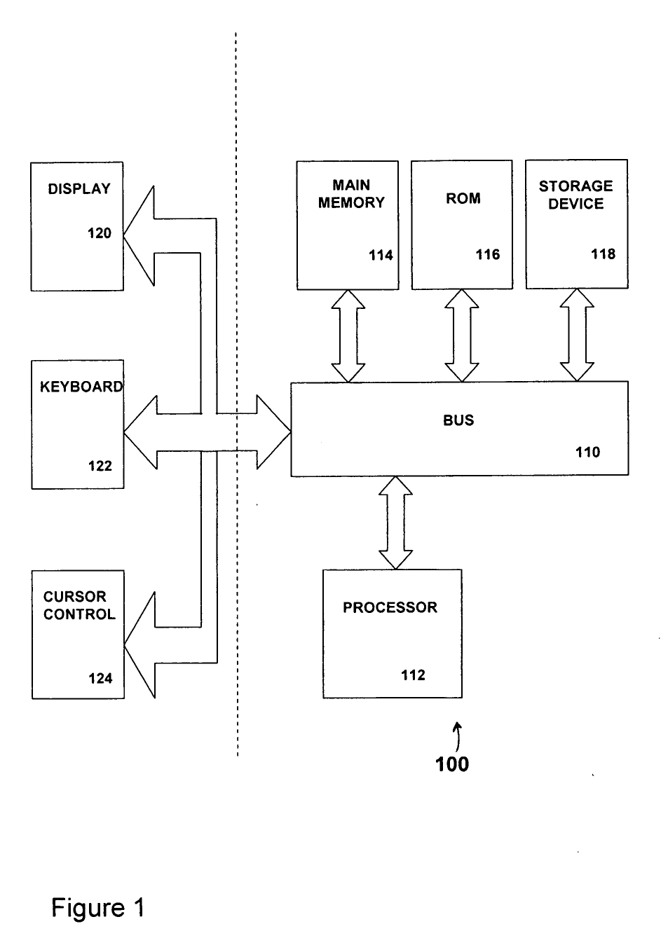

FIG. 1 shows a high-level block diagram of a computer system 100 with which an embodiment of the present disclosure can be implemented. Computer system 100 includes a bus 110 or other communication mechanism for communicating information and a processor 112, which is coupled to the bus 110, for processing information. Computer system 100 further comprises a main memory 114, such as a random access memory (RAM) and/or another dynamic storage device, for storing information and instructions to be executed by the processor 112. For example, the main memory is capable of storing a program, which is a sequence of computer readable instructions, for performing the method of the present disclosure. The main memory 114 may also be used for storing temporary variables or other intermediate information during execution of instructions by the processor 112.

Computer system 100 also comprises a read only memory (ROM) 116 and/or another static storage device. The ROM is coupled to the bus 110 for storing static information and instructions for the processor 112. A data storage device 118, such as a magnetic disk or optical disk and its corresponding disk drive, can also be coupled to the bus 110 for storing both dynamic and static information and instructions.

Input and output devices can also be coupled to the computer system 100 via the bus 110. For example, the computer system 100 uses a display unit 120, such as a cathode ray tube (CRT), for displaying information to a computer user. The computer system 100 further uses a keyboard 122 and a cursor control 124, such as a mouse.

The present disclosure is a method for generating an ideographic representation of a named entity from its representation in an alphabetized, letter-based system. Although the following description uses Latin script as an example, the present disclosure is not so limited. The method of the present disclosure can be performed via a computer program that operates on a computer system, such as the computer system 100 illustrated in FIG. 1. According to one embodiment, language origin identification and language-specific transcription are performed by the computer system 100 in response to the processor 112 executing sequences of instructions contained in the main memory 114. Such instructions may be read into the main memory 114 from another computer-readable medium, such as the data storage device 118. Execution of the sequences of instructions contained in the main memory 114 causes the processor 112 to perform the method that will be described hereafter. In alternative embodiments, hard-wired circuitry could replace or be used in combination with software instructions to implement the present disclosure. Thus, the present disclosure is not limited to any specific combination of hardware circuitry and software.

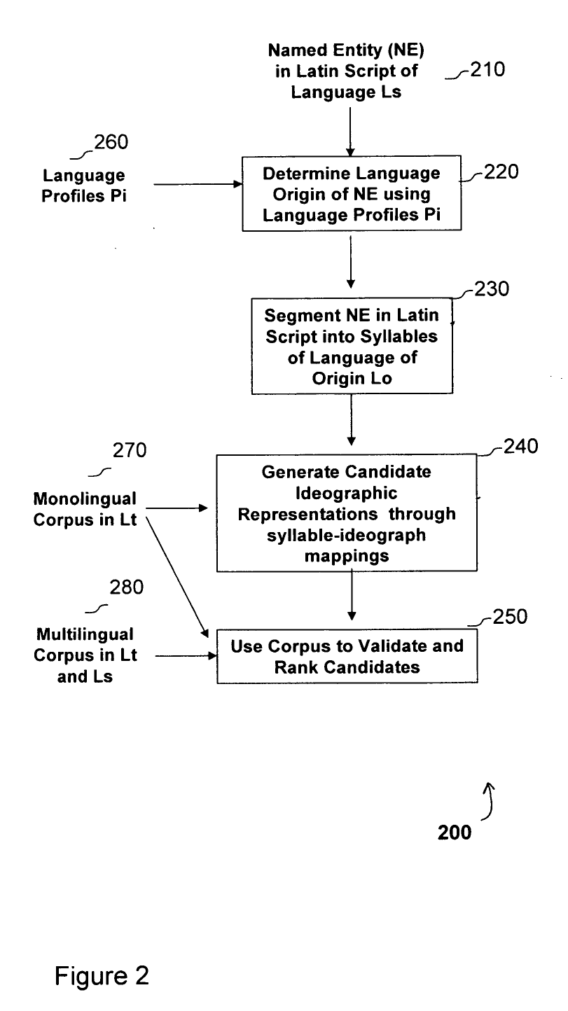

FIG. 2 illustrates a process-flow diagram 200 for a method of generating an ideographic representation of a named entity written in a Latin script. The method can be implemented on the computer system 100 illustrated in FIG. 1. An embodiment of the method of the present disclosure includes the step of the computer system 100 operating over a file of named entities in a source language 210. The selection of a file is normally a user input through the keyboard 122 or other similar device to the computer system 100. The generated ideographic representations of the named entities can be represented to the user via display device 120.

Given a named entity in a Latin or other script, the step 220 identifies the language origin(s) of the named entity using pre-prepared language profiles 260. A language profile (Pᵢ) may be, in one embodiment, a set of feature and weight pairs that are representative of a particular language i.

The language profiles 260 may be constructed via a process illustrated in FIG. 3. Turning to FIG. 3, at step 310, given a language Lᵢ, named entities from that language are collected and their Romanized representations are obtained. Alternatively, a list of common words can be used as a substitute of a list of named entities and their Romanized representations are obtained. At step 320, in an embodiment of language profile generation, Romanized representations of the named entities originated in language Lᵢ are converted into overlapping character-based n-grams, where n can be 1, 2, 3, or other numbers. As an example, the name “koizumi” of Japanese origin can be represented as character trigram (i.e., n=3) sequences “ˆko”, “koi”, “oiz”, “izu”, zum”, “umi”, “mi$”, with “ˆ” representing the start character and “$” the end character. Alternatively, profiles Pᵢ can be constructed based on other types of n-grams, a combination of different types of n-grams, or a combination of n-grams and short words.

Each trigram from the language Lᵢ is assigned a weight, calculated as the frequency of observing the trigram in the list over the sum of all trigrams of the language Lᵢ. The set of trigrams with their normalized weights construct the language profile Pᵢ of Lᵢ. Alternatively, the weight of a feature can be calculated by combining its frequency in one language and its distribution across languages, as is described in patent application Ser. No. 10/757,313 (Filing date: Jan. 14, 2004).

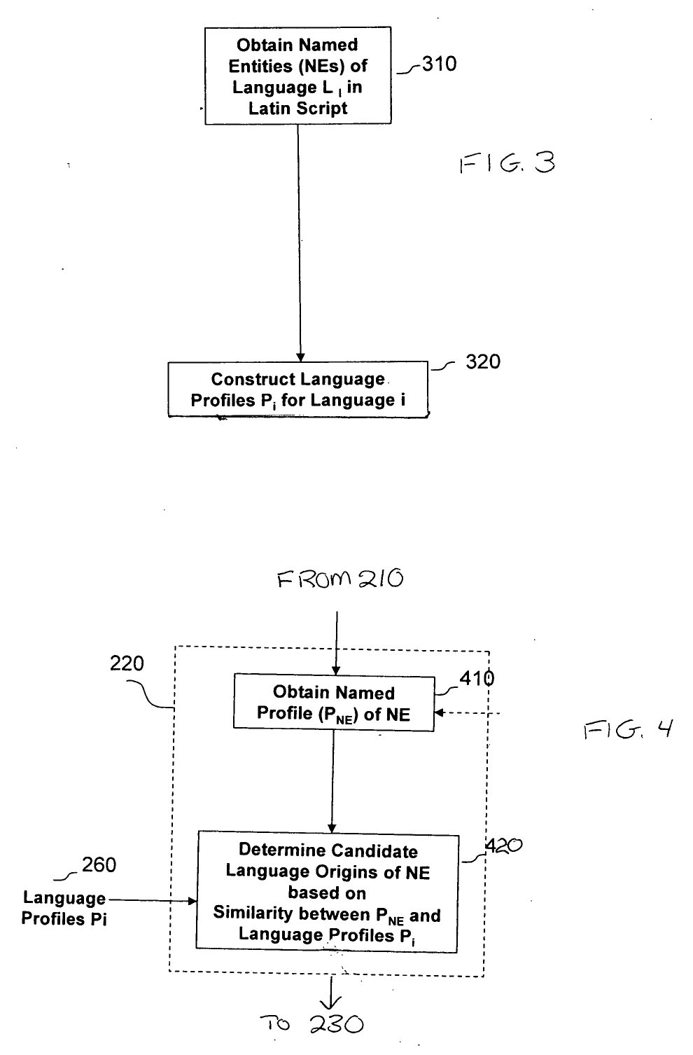

Returning to step 220 in FIG. 2, a given named entity in a Latin script is compared with the language profiles 260 for language origin identification. An embodiment of language origin identification of a given named entity is illustrated in FIG. 4.

Turning to FIG. 4, in step 410, a profile P_{NE} consisting of features and their weights is created for representing the named entity. An embodiment of a named entity profile is based on overlapping character-based n-grams, with their weights being the frequencies of observing the n-grams in the named entity. Again, n can be 1, 2, 3, or other numbers; or the features can be a combination of n-grams and short words. The types of features generated for the named entity should be the same as the features used for generating the language profiles Pᵢ. The weight of each feature is calculated as described above. More particularly, the weight of each feature may be calculated as the frequency of observing the feature in NE. Alternatively, the weight of each feature may be calculated based on the frequency and distribution of the feature across languages, as described in patent application Ser. No. 10/757,313 filed Jan. 14, 2004.

In step 420, candidate language origins of the named entity are selected based on the similarities between P_{NE} and the individual language profiles Pᵢ. An embodiment for computing the similarity between P_{NE} and a language profile Pᵢ is as follows:
Set SimilarityScore=0;
For each feature in P_{NE},
   Find its normalized value in Pᵢ;
   Multiply the normalized value by its weight in P_{NE};
   Add the multiplied value to SimilarityScore;
Return SimilarityScore.
   Depending on the needs of applications, either the top one or the top N language profiles can be selected as candidate language origins ranked by the decreasing order of the similarity scores. Alternatively, candidates can be selected based on the similarity scores, enforcing that the similarity scores be above a threshold value.

Returning to FIG. 2, once a candidate language origin of the given named entity is determined, language-specific resources are selected for properly transcribing representations in the Latin script to ideographic representations, including the syllabary of the original language and language corpora in the target language which are used in the subsequent steps.

In step 230, the named entity written in a Latin script is segmented into character sequence segments that correspond to the character or syllable segments in its language of origin based on the syllabary of the language of origin. For example, the string “koizumi” is recognized as of Japanese origin, so the Japanese syllabray is used for segmenting the string. A preferred embodiment is to obtain all the possible segmentations for the string. That is, “koizumi” can be segmented in three possible segmentations “ko-izumi”, “koi-zu-mi”, “ko-i-zu-mi”, in which “-” denotes the place where the characters can be separated.

In step 240, from the segmented sequences, ideographic representations of the sequences are generated, which makes use of mappings between the syllables in the Latin script and the ideographic characters of these syllables represented in CJK languages. One example resource of such mappings is the Unihan database, prepared by the Unicode Consortium (www.unicode.org/charts/unihan.html). The Unihan database, which contains more than 54,000 Chinese characters found in Chinese, Japanese, and Korean, provides a variety of information about these characters, such as the definition of a character, its values in different encoding systems, and the pronunciation(s) of the character in Chinese (listed under the feature kMandarin in the Unihan database), in Japanese (both the On reading and the Kun reading: kJapaneseKun and kJapaneseOn), and in Korean (kKorean). For example, for the kanji character [symbol] coded with Unicode hexadecimal character 91D1, the Unihan database lists 49 features; its pronunciations in Japanese, Chinese, and Korean are listed below:
U+91D1 kJapaneseKun KANE
U+91D1 kJapaneseOn KIN KON
U+91D1 kKorean KIM KUM
U+91D1 kMandarin JIN1 JIN4

In the example above, [symbol] is represented in its Unicode scalar value in the first column, with a feature name in the second column and the values of the feature in the third column. For example, the Japanese Kun reading of [symbol] is KANE, while the Japanese On readings of [symbol] is KIN and KON.

From a resource such as the Unicode database, mappings between the phonetic representations of CJK characters in the Latin script and the characters in their ideographic representations are constructed. For example, consider the mappings between Japanese phonetic representations and the Chinese characters. As the Chinese characters in Japanese names can have either the Kun reading or the On reading, both readings are considered as candidates for each kanji (i.e., Chinese) character. A typical mapping is as follows:
kou U+4EC0 U+5341 U+554F U+5A09 U+5B58 U+7C50 U+7C58 . . .
in which the first field specifies a pronunciation represented in the Latin script, while the rest of the fields specifies the possible kanji characters into which the pronunciation can be mapped.

Continuing in step 240, for a segmented sequence as a result of segmenting the named entity string in the Latin script, the candidate ideographic representations of the sequence are generated based on a character bigram model of the target language.

First, a monolingual corpus 270 in the target language is processed into character (i.e., ideograph) bigrams. The use of a bigram language model can significantly reduce the hypothesis space. For example, with the segmentation “ko-i-zu-mi”, even though “ko-i” can have 182*230 possible combinations based on mappings between phonetic representations and characters, only 42 kanji combinations that are attested by the language model of the reference corpus are attained.

Continuing with the segment “i-zu”, the possible kanji combinations for “i-zu” that can continue one of the 42 candidates for “ko-i” are generated. This results in only 6 candidates for the segment “ko-i-zu”.

Lastly, with the segment “zu-mi”, only 4 candidates are retained for the segmentation “ko-i-zu-mi” whose bigram sequences are attested in our language model:
U+5C0F U+53F0 U+982D U+8EAB
U+5B50 U+610F U+56F3 U+5B50
U+5C0F U+610F U+56F3 U+5B50
U+6545 U+610F U+56F3 U+5B50
The above process is applied to all the possible segmentation sequences for obtaining the candidate ideographic representations.

The process carried out in step 240 may be summarized as follows. Given a syllable sequence, parse the sequence into overlapping syllable n-grams, e.g., n=2. For each n-gram, if a mapping to ideogram is possible, and the mapping is attested (validated) in the corpus, then combine with earlier segments to form candidate representation, and continue with the next n-gram. If there is no mapping, then the system should return an error message or some other message indicating that the segment to ideogram mapping has failed.

For some multilingual applications, the set of candidate ideographic representations from step 240 may be sufficient as transcriptions or translations of the named entity in the target language. Certain processes in these applications may be able to filter or rank the candidates to keep only the candidates that are useful.

For other applications, such as constructing a translation lexicon of named entities, it may be desirable to have the validation built-in. In step 250 of FIG. 2, the candidate ideographic representations are validated and ranked with respect to text corpora.

An embodiment of such a validation is achieved by validating the candidate ideographic representations against a monolingual corpus in the target language. The monolingual corpus (e.g., corpus 270 in FIG. 2) is first processed into a list of linguistic units such as words and phrases with their corresponding occurrence frequencies. The candidate set of ideographic representations are then compared with the list and are ranked by their occurrence frequencies if they are attested. A predetermined threshold can be used to cut off candidates that have low occurrence frequencies. Alternatively, the corpus can be processed into character n-grams with their associated frequencies. Validation of the candidate ideographic representations then is done against the character n-grams and their statistics.

An alternative embodiment of validation is achieved by validating the candidate ideographic representations against a multilingual corpus consisting of text in both the source language and the target language (e.g., corpus 280 in FIG. 2). First, the multilingual corpus is processed into linguistic units such as words and phrases based on the lexicons of the languages involved. Then, within a text window, pairings of the words or phrases written in the Latin script and the words and phrases in ideographic representations are constructed and their occurrence frequencies are recorded. The text window can be a text segment of a pre-determined byte size, a sentence, a paragraph, a document, etc. During validation, the name entity in the Latin script is paired with each candidate ideographic representation of the named entity; the pairing is validated against the pairings collected from the multilingual corpus. If the pairing is attested in the multilingual corpus, then its corpus occurrence frequency is used as the score for the pairing. A predetermined threshold can be used to cut off candidates that have low occurrence frequencies

As an alternative, one can consider the World Wide Web as a multilingual corpus. With the Web, each pairing of the named entity in the Latin script and a candidate ideographic representation is treated as a query and is sent to the Web to bring back Web page counts as a result of Web search (e.g., using the Web search engine Google). All the pairings are ranked in a decreasing order of their page counts, with the higher counts suggesting the more likelihood of seeing the combinations together. For example, for the name “koizumi”, combined with some of its candidate ideographic representations, Google.com produces the following Web page counts as of the date of this writing:
[symbol] koizumi”—237,000 pages
[symbol] koizumi”—302 pages
[symbol] koizumi”—3 pages
   Additionally, the candidates can be furthered constrained by enforcing that the candidates appear in top N ranking or that the candidates have scores above a certain frequency threshold.

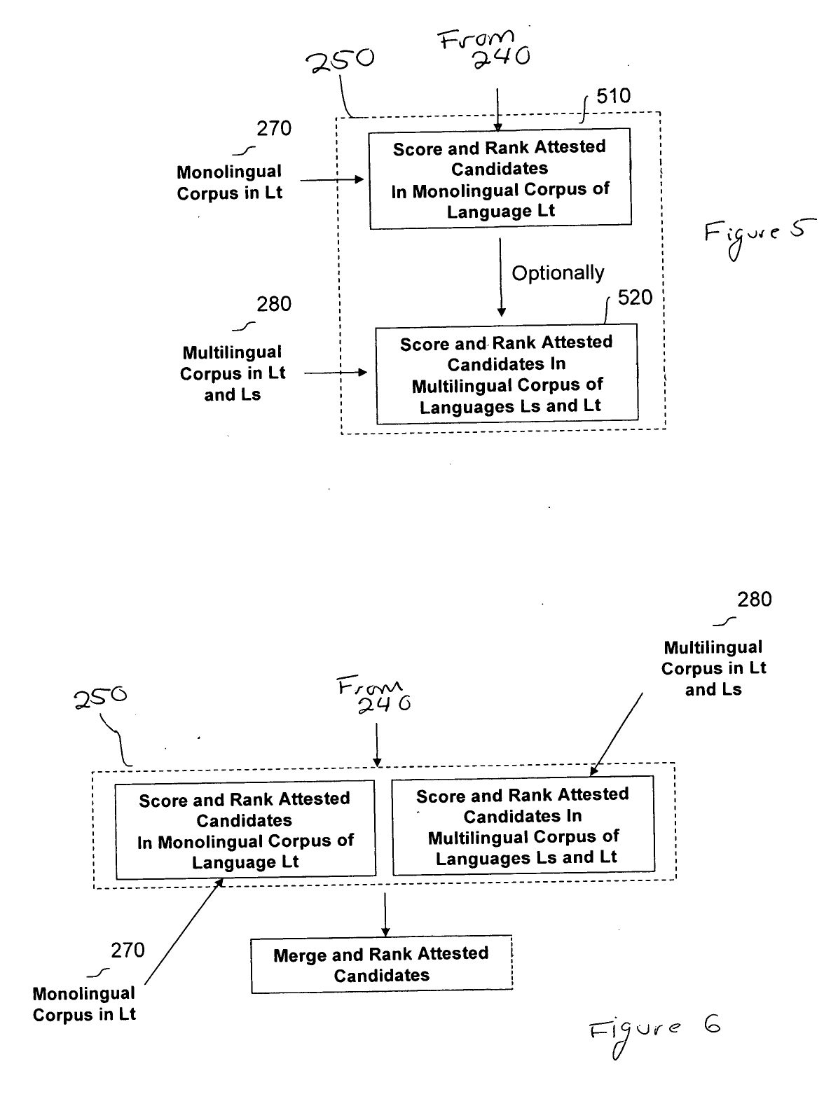

As yet another alternative, validation through a monolingual corpus of the target language and through a multilingual corpus of the source language and the target language can be combined. FIG. 5 illustrates an embodiment of step-wise validation based on these two types of corpora. For validation, candidate ideographic representations are first validated against the monolingual corpus as described earlier. Then the kept candidates resulting from this validation process are passed for further validation against the multilingual corpus using similar or different thresholds.

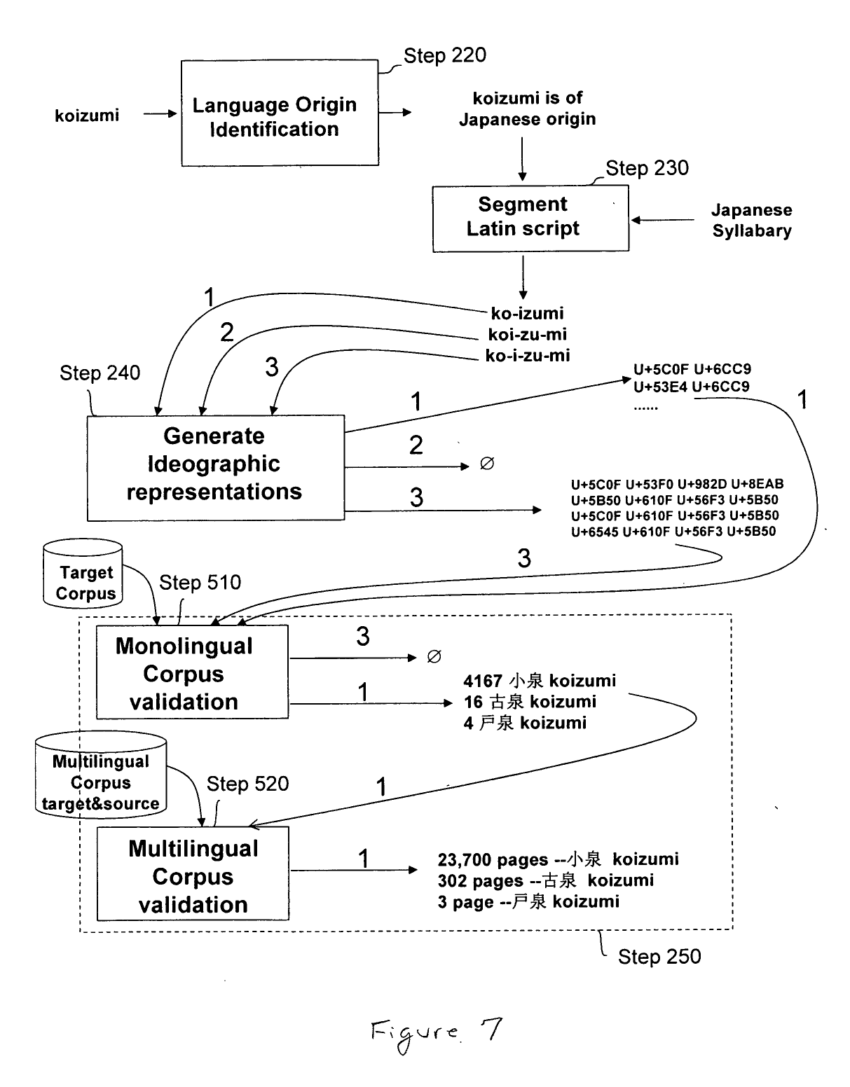

Another embodiment of combining the validation processes is illustrated in FIG. 6, in which validation against the monolingual and the multilingual corpora is carried out in parallel, and then validated results are combined to form a merged list based on either merging the ranks or scores.

Turning now to FIG. 7, FIG. 7 illustrates an example of how the process 200 of FIG. 2 may be implemented. In the example of FIG. 7, the name koizumi is input to the system. At step 220, the language of origin is identified as Japanese. At step 230, the Latin script koizumi is segmented into syllables using the Japanese syllabary. That process produces three segmentation sequences: “ko-izumi”; “koi-zu-mi”; “ko-i-zu-mi”. Those three segmentation sequences are input to step 240 in which a candidate representation for each segmentation sequence based on ideographic representations of the segments is generated. As can be seen in FIG. 7, two candidate representations are produced from the first segmentation sequence, no candidate representations are produced for the second segmentation sequence (the mapping failed), and four candidate representations are generated from the third segmentation sequence.

The various candidate representations are input to step 250 which, in this case, is implementing the stepwise validation illustrated in FIG. 5. Thus, a monolingual corpus validation is used first to rank the candidate representations. Thereafter, a multilingual corpus is used to rank the candidate representations. As can be seen from the example, the multilingual corpus validation step 520 produced similar results as those produced by the monolingual corpus validation 510.

Although the disclosure has been described and illustrated with respect to the exemplary embodiments thereof, it should be understood by those skilled in the art that the foregoing and various other changes, omissions, and additions may be made without departing from the spirit and scope of the disclosure.

What is claimed is:

1. A method of generating an ideographic representation of a name given in a letter based system, comprising:
determining a language of origin for the name;
segmenting said name into a segmentation sequence in response to the determined language of origin;
generating a candidate representation for said segmentation sequence based on ideographic representations of said segments; and
using a corpus to validate said candidate representation.

2. The method of claim 1 wherein said generating a candidate representation includes using a segment to ideograph mapping.

3. The method of claim 1 wherein said corpus includes one of a monolingual corpus and a multilingual corpus.

4. The method of claim 1 wherein said corpus includes a monolingual corpus, said method additionally comprising using a multilingual corpus to validate said candidate representation.

5. A method of generating an ideographic representation of a name given in a letter based system, comprising:
determining a language of origin for the name;
segmenting said name into a plurality of segmentation sequences in response to the determined language of origin;
generating a candidate representation for each segmentation sequence based on ideographic representations of said segments to produce a plurality of candidate representations; and
using a corpus to rank said plurality of candidate representations.

6. The method of claim 5 wherein said segmenting includes segmenting said name into all possible segmentation sequences.

7. The method of claim 5 wherein said generating a candidate representation includes using a segment to ideograph mapping.

8. The method of claim 5 wherein said using a corpus includes using a corpus to score each of said candidate representations, and wherein said rank is based upon said score.

9. The method of claim 5 wherein said corpus includes one of a monolingual corpus and a multilingual corpus.

10. The method of claim 5 wherein said corpus includes a monolingual corpus, said method additionally comprising using a multilingual corpus to rank said plurality of candidate representations.

11. A method of generating an ideographic representation of a name given in a letter based system in which a language of origin of the given name is known, comprising:
segmenting the name into a segmentation sequence in response to a language of origin;
generating a candidate representation for said segmentation sequence based on ideographic representations of said segments;
using a monolingual corpus to validate said candidate representation; and
using a multilingual corpus to validate said candidate representation.

12. The method of claim 11 wherein said generating a candidate representation includes using a segment to ideograph mapping.

13. A method of generating an ideographic representation of a name given in a letter based system in which a language of origin of the given name is known, comprising:
segmenting the name into a plurality of segmentation sequences in response to a language of origin;
generating a candidate representation for each segmentation sequence based on ideographic representations of said segments to produce a plurality of candidate representations;
using a monolingual corpus to rank said plurality of candidate representations; and
using a multilingual corpus to rank said plurality of candidate representations.

14. The method of claim 13 wherein said segmenting includes segmenting said name into all possible segmentation sequences.

15. The method of claim 13 wherein said generating a candidate representation includes using a segment to ideograph mapping.

16. The method of claim 13 wherein said using a monolingual corpus includes using a monolingual corpus to score each of said candidate representation, and wherein said rank is based upon said score.

17. The method of claim 13 wherein said using a multilingual corpus includes using a multilingual corpus to score certain of said candidate representations highly ranked by said monolingual corpus, and ranking said certain of said candidate representations based on said score.

18. A computer readable medium carrying a set of instructions which, when executed, perform a method comprising:
determining a language of origin for a name;
segmenting said name into a segmentation sequence in response to the determined language of origin;
generating a candidate representation for said segmentation sequence based on ideographic representations of said segments; and
using a corpus to validate said candidate representation.

19. A computer readable medium carrying a set of instructions which, when executed, perform a method comprising:
determining a language of origin for a name;
segmenting said name into a plurality of segmentation sequences in response to the determined language of origin;
generating a candidate representation for each segmentation sequence based on ideographic representations of said segments to produce a plurality of candidate representations; and
using a corpus to rank said plurality of candidate representations.

20. A computer readable medium carrying a set of instructions which, when executed, perform a method comprising:
segmenting a name into a segmentation sequence in response to a language of origin;
generating a candidate representation for said segmentation sequence based on ideographic representations of said segments;
using a monolingual corpus to validate said candidate representation; and
using a multilingual corpus to validate said candidate representation.

21. A computer readable medium carrying a set of instructions which, when executed, perform a method comprising:
segmenting a name into a plurality of segmentation sequences in response to a language of origin;
generating a candidate representation for each segmentation sequence based on ideographic representations of said segments to produce a plurality of candidate representations;
using a monolingual corpus to rank said plurality of candidate representations; and
using a multilingual corpus to rank said plurality of candidate representations.
